(19) United States
(12) Patent Application Publication
(10) Pub. No.: US 2021/0364019 A1
(43) Pub. Date: Nov. 25, 2021

(54) FASTENER STRUCTURE

(71) Applicant: FIVETECH TECHNOLOGY INC., New Taipei City (TW)

(72) Inventors: TING-JUI WANG, New Taipei City (TW); HSIEN-CHANG CHEN, New Taipei City (TW)

(21) Appl. No.: 17/216,692

(22) Filed: Mar. 30, 2021

(30) Foreign Application Priority Data
May 25, 2020 (TW) 109206429

(51) Int. Cl. F16B 2/02

(52) U.S. Cl. CPC F16B 2/02

(57) ABSTRACT

A fastener structure includes a casing, an engaging element and a controlling element. The engaging element is movably disposed at the casing. The controlling element is movably disposed at the casing. The controlling element controls the engaging element to enter a locked state or unlocked state. Therefore, the casing is fitted to the first object, such that engaging element is fastened to or unfastened from the second object, so as to couple together quickly and separate easily at least two objects.

### CROSS-REFERENCE TO RELATED APPLICATION

This non-provisional application claims priority under 35 U.S.C. § 119(a) on Patent Application No(s). 109206429 filed in Taiwan, R.O.C. on May 25, 2020, the entire contents of which are hereby incorporated by reference.

### BACKGROUND OF THE INVENTION

### 1. Field of the Invention

The present disclosure relates to fastener structures, and in particular to a fastener structure adapted to couple together quickly and separate easily at least two objects.

### 2. Description of the Related Art

According to prior art, two objects, such as covers, doors, boxes and cabinets, are coupled together with screws effectively.

However, the prior art has drawbacks. Once coupled together, the two objects can only be separated by removing the screws therefrom. Furthermore, the aforesaid fastening structure is unable to couple together quickly and separate easily at least two objects. Therefore, it is important to provide a fastener structure adapted to couple together quickly and separate easily at least two objects.

### BRIEF SUMMARY OF THE INVENTION

An objective of the present disclosure is to provide a fastener structure adapted to couple together quickly and separate easily at least two objects.

To achieve at least the above objective, the present disclosure provides a fastener structure comprising a casing, an engaging element and a controlling element. The engaging element is movably disposed at the casing. The controlling element is movably disposed at the casing. The controlling element controls the engaging element to enter a locked state or unlocked state.

In the fastener structure, the casing has at least a joining portion for allowing the casing to be fitted to a first object and allowing the engaging element to be fastened to or unfastened from a second object.

In the fastener structure, the engaging element comprises a limiting portion and an engaging portion. The controlling element restricts or releases the limiting portion, such that the engaging portion is fastened to or unfastened from a second object.

In the fastener structure, the engaging element is movably disposed at the casing, using a shaft.

In the fastener structure, the engaging element further comprises a first resilient component disposed at the shaft. The first resilient component has one end abutting against the casing and the other end abutting against the engaging element.

In the fastener structure, the controlling element comprises an operating portion and a restricting portion. The operating portion drives the restricting portion, such that the restricting portion restricts or releases the engaging element, allowing the engaging element to be fastened to or unfastened from a second object.

In the fastener structure, the casing has a support portion, such that the operating portion is movable between the casing and the support portion.

In the fastener structure, the restricting portion is movably disposed at the casing, using an axle portion.

In the fastener structure, the controlling element further comprises a second resilient component. The second resilient component has one end abutting against the casing and the other end abutting against the restricting portion.

In the fastener structure, the operating portion has a slot, and the restricting portion is movably disposed at the slot.

In the fastener structure, the operating portion has a guide surface, and the restricting portion has a corresponding guide surface. The guide surface of the operating portion and the corresponding guide surface of the restricting portion abut against each other and move relative to each other, thereby allowing the operating portion to drive the restricting portion.

In the fastener structure, the casing further comprises a light guiding plate.

In the fastener structure, the light guiding plate has a first light admitting portion, a second light admitting portion, a first light emitting portion and a second light emitting portion. The first light admitting portion is in communication with the first light emitting portion. The second light admitting portion is in communication with the second light emitting portion.

In the fastener structure, electrically-conductive leaf springs are disposed on the surface of the casing.

Therefore, the fastener structure of the present disclosure enables a casing to be fitted to a first object, such that an engaging element is fastened to or unfastened from a second object, so as to couple together quickly and separate easily at least two objects.

### BRIEF DESCRIPTION OF THE DRAWINGS

FIG. 1 is a perspective view of a preferred embodiment of the present disclosure.

FIG. 2 is an exploded view of a preferred embodiment of the present disclosure.

FIG. 3 is an exploded view of a preferred embodiment of the present disclosure.

FIG. 4 is a schematic view 1 of operation of a preferred embodiment of the present disclosure.

FIG. 5 is a schematic view 2 of operation of a preferred embodiment of the present disclosure.

FIG. 6 is a schematic view 3 of operation of a preferred embodiment of the present disclosure.

FIG. 7 is a schematic view 4 of operation of a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

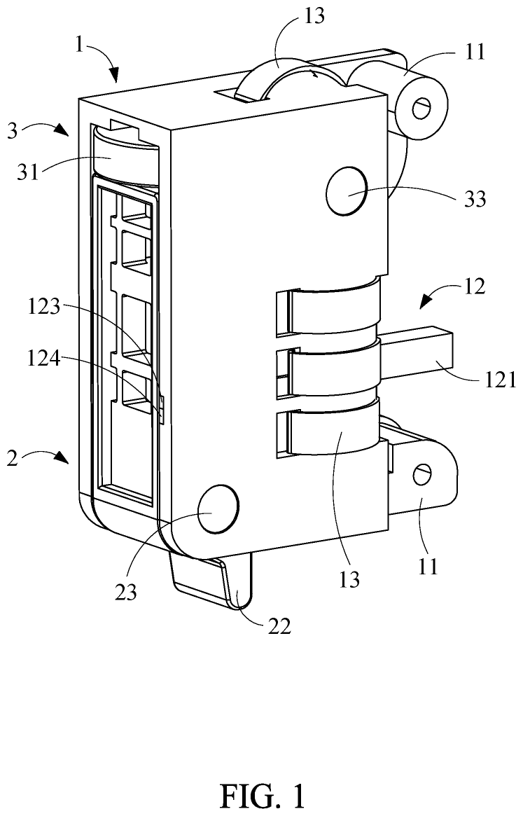

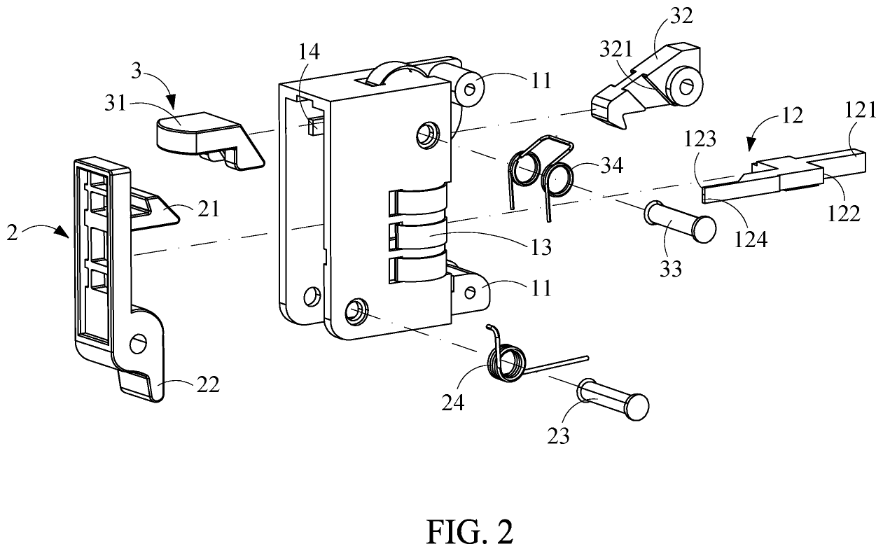

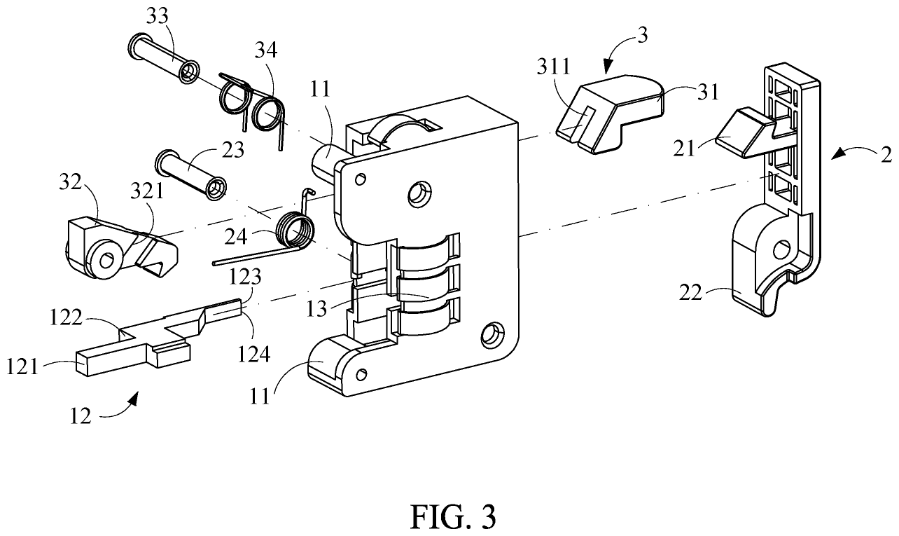

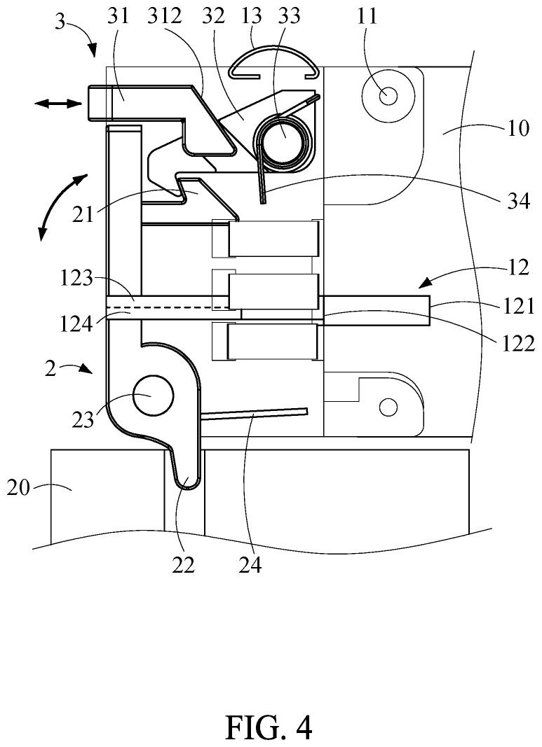

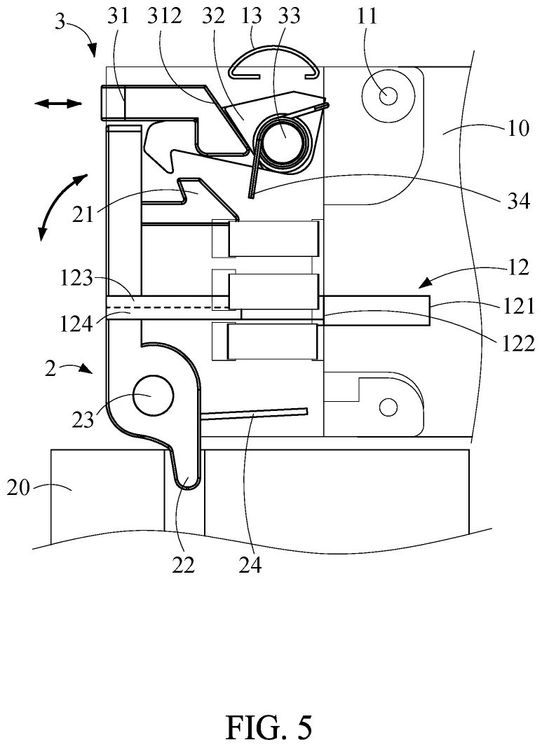

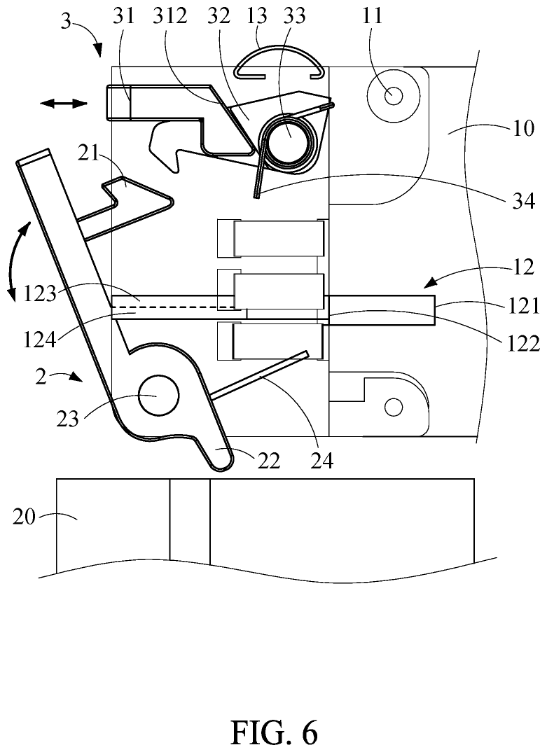

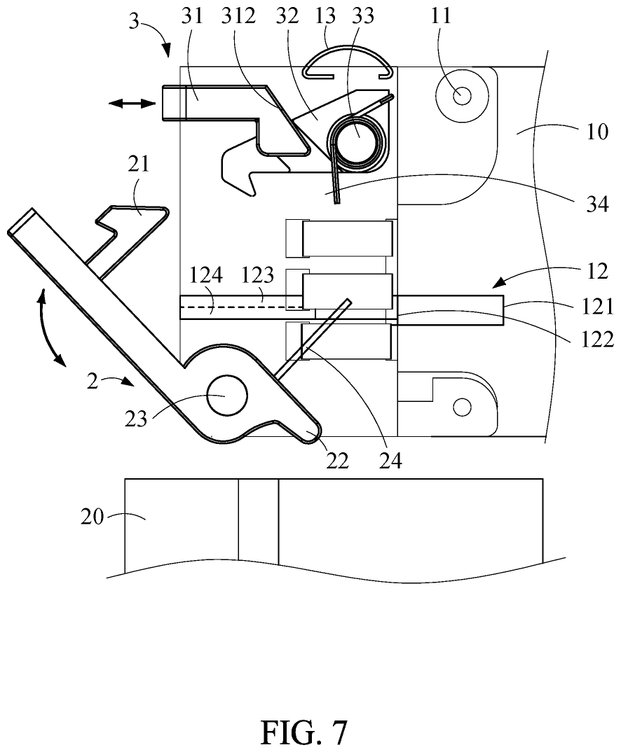

Referring to FIG. 1 through FIG. 7, the present disclosure provides a fastener structure which comprises a casing 1, an engaging element 2 and a controlling element 3.

The engaging element 2 is movably disposed at the casing 1.

The controlling element 3 is movably disposed at the casing 1 and adapted to control the engaging element 2 to enter a locked state or unlocked state.

The casing 1 is fitted to a first object 10. The controlling element 3 restricts the engaging element 2, and thus the engaging element 2 is fastened to a second object 20. Alternatively, the controlling element 3 releases the engaging element 2, and thus the engaging element 2 is unlocked from the second object 20. The user exerts a force on the engaging element 2 to pull the casing 1 and the first object 10, so as to couple together quickly and separate easily at least two objects.

In an embodiment of the present disclosure, the casing 1 has at least a joining portion 11 for allowing the casing 1 to be fitted to the first object 10, such that the engaging element 2 is fastened to or unfastened from the second object 20, so as to couple together quickly and separate easily at least two objects.

In an embodiment of the present disclosure, the engaging element 2 comprises a limiting portion 21 and an engaging portion 22. The controlling element 3 restricts or releases the limiting portion 21, such that the engaging portion 22 is fastened to or unfastened from the second object 20, so as to couple together quickly and separate easily at least two objects.

In an embodiment of the present disclosure, the engaging element 2 comprises a shaft 23 and is movably disposed at the casing 1 by means of the shaft 23. Thus, the controlling element 3 and the limiting portion 21 effect restriction, such that the engaging element 2 rotates about the shaft 23 and thereby moves toward the casing 1 to allow the engaging portion 22 to engage with the second object 20 and allow the controlling element 3 to restrict the limiting portion 21 from entering a locked state. When the controlling element 3 releases the limiting portion 21, the engaging element 2 rotates about the shaft 23 and thus moves outward in a direction away from the casing 1. The engaging portion 22 separates from the second object 20 and thus enters an unlocked state. The user exerts a force on the engaging element 2 to pull the casing 1 and the first object 10, so as to couple together quickly and separate easily at least two objects.

In an embodiment of the present disclosure, the engaging element 2 further comprises a first resilient component 24. The first resilient component 24 is disposed at the shaft 23. One end of the first resilient component 24 abuts against the casing 1. The other end of the first resilient component 24 abuts against the engaging element 2. Thus, when the engaging element 2 moves inward toward the casing 1, the engaging portion 22 engages with the second object 20, allowing the controlling element 3 to restrict the limiting portion 21 from entering a locked state and compress the first resilient component 24, so as to maintain the stability of the locked state. By contrast, when the controlling element 3 releases the limiting portion 21, the resilience of the first resilient component 24 is released, such that the engaging element 2 automatically moves outward in a direction away from the casing 1, thereby allowing the engaging portion 22 and the second object 20 to separate and thereby enter an unlocked state. The user exerts a force on the engaging element 2 to pull the casing 1 and the first object 10, so as to couple together quickly and separate easily at least two objects.

In an embodiment of the present disclosure, the controlling element 3 comprises an operating portion 31 and a restricting portion 32. The operating portion 31 drives the restricting portion 21; thus, the restricting portion 32 restricts or releases the limiting portion 21 of the engaging element 2, such that the engaging portion 22 of the engaging element 2 is fastened to or unfastened from the second object 20. Thus, the controlling element 3 and the limiting portion 21 effect restriction, such that the engaging element 2 rotates about the shaft 23, so as to allow the engaging element 2 to move inward toward the casing 1, allow the restricting portion 32 to engage with the restricting portion 21, and compress the first resilient component 24, such that the engaging portion 22 engages with the second object 20, and the controlling element 3 restricts the limiting portion 21 from entering a locked state. The unlocking process involves pressing the operating portion 31 and thereby causing the operating portion 31 to drive the restricting portion 32, so as to allow the restricting portion 32 to release the limiting portion 21, allow the engaging element 2 to rotate about the shaft 23 and thereby move outward in a direction away from the casing 1, and allow the engaging portion 22 and the second object 20 to separate and thereby enter an unlocked state. The user exerts a force on the engaging element 2 to pull the casing 1 and the first object 10, so as to couple together quickly and separate easily at least two objects.

The casing 1 is provided with a support portion 14, such that the operating portion 31 is movable between the casing 1 and the support portion 14. Thus, the operating portion 31 moves between the casing 1 and the support portion 14 and thereby drives the restricting portion 21, so as to allow the restricting portion 32 to restrict or release the limiting portion 21 of the engaging element 2, such that the engaging portion 22 of the engaging element 2 is fastened to or unfastened from the second object 20.

In an embodiment of the present disclosure, the restricting portion 32 is movably disposed at the casing 1 by means of an axle portion 33. Thus, the controlling element 3 and the limiting portion 21 effect restriction, such that the engaging element 2 rotates about the shaft 23 to allow the engaging element 2 to move inward toward the casing 1, allow the restricting portion 32 to rotate about the axle portion 33, allow the restricting portion 32 to move the engaging-restricting portion 21 downward, and compress the first resilient component 24, such that the engaging portion 22 engages with the second object 20, and the controlling element 3 restricts the limiting portion 21 from entering a locked state. The unlocking process involves pressing the operating portion 31 and thereby causing the operating portion 31 to drive the restricting portion 32, so as to allow the restricting portion 32 to rotate about the axle portion 33, allow the restricting portion 32 to move upward and release the limiting portion 21, allow the engaging element 2 to rotate about the shaft 23 and thereby move outward in a direction away from the casing 1, and allow the engaging portion 22 and the second object 20 to separate and thereby enter an unlocked state. The user exerts a force on the engaging element 2 to pull the casing 1 and the first object 10, so as to couple together quickly and separate easily at least two objects.

In an embodiment of the present disclosure, the controlling element 3 further comprises a second resilient component 34. One end of the second resilient component 34 abuts against the casing 1. The other end of the second resilient component 34 abuts against the restricting portion 32. Thus, the controlling element 3 and the limiting portion 21 effect restriction, such that the engaging element 2 rotates about the shaft 23, so as to allow the engaging element 2 to move inward toward the casing 1, allow the restricting portion 32 to be centered at the axle portion 33, allow the second resilient component 34 to be resiliently released, allow the restricting portion 32 to move the engaging-restricting portion 21 downward, and compress the first resilient component 24. Thus, the engaging portion 22 engages with the second object 20, and the controlling element 3 restricts the limiting portion 21 from entering a locked state. The unlocking process involves pressing the operating portion 31 and thereby causing the operating portion 31 to drive the restricting portion 32, and in consequence the restricting portion 32 is centered at the axle portion 33, so as to allow the restricting portion 32 to move upward and release the limiting portion 21, compress the second resilient component 34, allow the engaging element 2 to rotate about the shaft 23 and thereby move outward in a direction away from the casing 1, allow the engaging portion 22 and the second object 20 to separate and thereby enter an unlocked state, and allow the second resilient component 34 to restore the position thereof after being unlocked and thereby lock again, so as to couple together quickly and separate easily at least two objects.

In an embodiment of the present disclosure, the operating portion 31 has a slot 311, and the restricting portion 32 is movably disposed at the slot 311. Thus, when the restricting portion 32 moves the engaging-restricting portion 21 downward or when the user presses the operating portion 31 to drive the restricting portion 32 moving upward and releasing the limiting portion 21, the restricting portion 32 is confined to the slot 311 and moved therein, so as to maintain the stability of the restricting portion 32 in operation.

In an embodiment of the present disclosure, the operating portion 31 has a guide surface 312, whereas the restricting portion 32 has a corresponding guide surface 321. The guide surface 312 of the operating portion 31 and the corresponding guide surface 321 of the restricting portion 32 abut against each other and move relative to each other; thus, the operating portion 31 drives the restricting portion 32, such that the restricting portion 32 restricts or releases the limiting portion 21 of the engaging element 2, thereby allowing the engaging portion 22 of the engaging element 2 to be fastened to or unfastened from the second object 20. Thus, when the restricting portion 32 moves the engaging-restricting portion 21 downward or when the user presses the operating portion 31 to drive the restricting portion 32 moving upward and releasing the limiting portion 21, not only is the restricting portion 32 confined to the slot 311 and moved therein, but the guide surface 312 of the operating portion 31 and the corresponding guide surface 321 of the restricting portion 32 also operate in conjunction with each other, so as to maintain the stability of the operating portion 31 while the operating portion 31 is driving the restricting portion 32 to operate.

In an embodiment of the present disclosure, the casing 1 further comprises a light guiding plate 12, whereas the first object 10 is a circuit board and emits light 101 toward the light guiding plate 12. The light guiding plate 12 guides the light 101, and thus the casing 1 indicates the connection state or operation state of the first object 10. Therefore, the present disclosure meets actual application needs.

In an embodiment of the present disclosure, the light guiding plate 12 has a first light admitting portion 121, a second light admitting portion 122, a first light emitting portion 123 and a second light emitting portion 124. The first light admitting portion 121 is in communication with the first light emitting portion 123. The second light admitting portion 122 is in communication with the second light emitting portion 124. Thus, the first object 10 emits the light 101 in first color according to the connection state or operation state, allowing the light 101 to enter the first light admitting portion 121 and exit the first light emitting portion 123. The first object 10 emits the light 101 in second color according to the connection state or operation state, allowing the light 101 to enter the second light admitting portion 122 and exit the second light emitting portion 124. Therefore, the present disclosure meets actual application needs.

In an embodiment of the present disclosure, electrically-conductive leaf springs 13 are disposed on the surface of the casing 1. Thus, after the casing 1 has been fitted to the first object 10, the second object 20 or any other objects, the electrically-conductive leaf springs 13 are in contact with the first object 10, the second object 20 or any other objects and thereby are grounded, so as to protect circuits and ensure safety of a power apparatus in operation.

While the present disclosure has been described by means of specific embodiments, numerous modifications and variations could be made thereto by those skilled in the art without departing from the scope and spirit of the present disclosure set forth in the claims.

What is claimed is:

1. A fastener structure, comprising:
a casing;
an engaging element movably disposed at the casing; and
a controlling element movably disposed at the casing and adapted to control the engaging element to enter a locked state or unlocked state.

2. The fastener structure of claim 1, wherein the casing has at least a joining portion for allowing the casing to be fitted to a first object and allowing the engaging element to be fastened to or unfastened from a second object.

3. The fastener structure of claim 1, wherein the engaging element comprises a limiting portion and an engaging portion, and the controlling element restricts or releases the limiting portion, such that the engaging portion is fastened to or unfastened from a second object.

4. The fastener structure of claim 1, wherein the engaging element is movably disposed at the casing, using a shaft.

5. The fastener structure of claim 4, wherein the engaging element further comprises a first resilient component disposed at the shaft, wherein the first resilient component has an end abutting against the casing and another end abutting against the engaging element.

6. The fastener structure of claim 1, wherein the controlling element comprises an operating portion and a restricting portion, and the restricting portion is driven by the operating portion to restrict or release the engaging element, such that the engaging element is fastened to or unfastened from a second object.

7. The fastener structure of claim 6, wherein the casing has a support portion, such that the operating portion is movable between the casing and the support portion.

8. The fastener structure of claim 6, wherein the restricting portion is movably disposed at the casing, using an axle portion.

9. The fastener structure of claim 7, wherein the controlling element further comprises a second resilient component, and the second resilient component has an end abutting against the casing and another end abutting against the restricting portion.

10. The fastener structure of claim 6, wherein the operating portion has a slot, and the restricting portion is movably disposed at the slot.

11. The fastener structure of claim 6, wherein the operating portion has a guide surface, and the restricting portion has a corresponding guide surface, such that the guide surface of the operating portion and the corresponding guide surface of the restricting portion abut against each other and move relative to each other, thereby allowing the operating portion to drive the restricting portion.

12. The fastener structure of claim 1, wherein the casing further comprises a light guiding plate.

13. The fastener structure of claim 12, wherein the light guiding plate has a first light admitting portion, a second light admitting portion, a first light emitting portion and a second light emitting portion, wherein the first light admitting portion is in communication with the first light emitting portion, wherein the second light admitting portion is in communication with the second light emitting portion.

14. The fastener structure of claim 1, wherein electrically-conductive leaf springs are disposed on a surface of the casing.
